(19) United States
(12) Patent Application Publication
(10) Pub. No.: US 2026/0048562 A1
(43) Pub. Date: Feb. 19, 2026

(54) 3D PRINTING OF OPTICAL LENSES BY PRECISION SPIN COATING

(71) Applicant: Purdue Research Foundation, West Lafayette, IN (US)

(72) Inventors: Huachao Mao, West Lafayette, IN (US); Yujie Shan, Lafayette, IN (US)

(73) Assignee: Purdue Research Foundation, West Lafayette, IN (US)

(21) Appl. No.: 19/303,112

(22) Filed: Aug. 18, 2025

Related U.S. Application Data
(60) Provisional application No. 63/684,311, filed on Aug. 16, 2024.

(51) Int. Cl. B29D 11/00; B29C 64/124; B29L 11/00; B33Y 10/00; B33Y 40/20; B33Y 80/00

(52) U.S. Cl. CPC B29D 11/00442; B29C 64/124; B29D 11/00865; B33Y 10/00; B33Y 40/20; B33Y 80/00; B29L 2011/0016

(57) ABSTRACT

A method is provided for fabricating an optical lens using vat photopolymerization (VPP). The method includes generating a digital lens model and printing the lens in discrete layers along a print direction. During printing, defocused image patterns are projected to mitigate lateral surface pixelation across the layers. Following printing, a photocurable resin is applied to the outer surface of the lens. The lens is then spin coated, distributing the resin uniformly and smoothing layered steps along the print direction. Finally, the coated resin is cured, producing a lens with improved surface quality.

### CROSS REFERENCE TO RELATED APPLICATIONS

This application claims the benefit of U.S. Provisional Application No. 63/684,311 filed Aug. 16, 2024, the entirety of each of which is hereby incorporated by reference.

### GOVERNMENT RIGHTS

This invention was made with government support under CMMI 2318677 and CMMI 2328362 awarded by the National Science Foundation. The government has certain rights in the invention.

### TECHNICAL FIELD

This disclosure relates to lens manufacturing and, in particular, to lens manufacturing with three-dimensional printing.

### BACKGROUND

Optical lenses are critical components in numerous optical systems, including microscopes, telescopes, laser beam delivery systems, human and machine vision systems, and augmented/virtual reality displays. Conventional fabrication of optical lenses requires time-consuming and expensive processes such as grinding, polishing, and precision molding. These methods, while effective, limit the speed and flexibility of lens prototyping and customization.

Additive manufacturing, particularly vat photopolymerization (VPP), has emerged as a promising alternative due to its high precision and rapid fabrication capabilities. However, typical VPP methods suffer from stair-stepping defects caused by the discrete nature of 3D printing layers and pixelated projection masks. These defects significantly degrade the optical quality of printed lenses

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a vat photopolymerization (VPP) 3D printing system.

FIG. 2A-B illustrates SEM images of lateral surface pixilation in a print layer with and without defocusing.

FIG. 3A-B illustrate SEM images of the vertical stair-stepping for a 3D printed lens before and after spin coating.

FIG. 4 illustrates a flow diagram for manufacturing the lens. The lens may be printed printing using a 3D printer.

FIG. 5 shows illustrate a measured coating profile of a spin coated lens. measurement of spin coating.

FIG. 6 illustrates analytical modeling of a lens manufactured according go the present disclosure.

### DETAILED DESCRIPTION

Optical lenses are the foundational elements in nearly all systems that utilize lights, for instance, imaging systems for microscope and telescope, illuminating systems, manufacturing systems for laser beam delivery, human and machine vision, and the virtual and mixed reality display for metaverse. Generally, the fabrication of these versatile lenses is a sophisticated process, involving the precise shaping, polishing, and assembly of transparent materials to manipulate the behavior of light. A sequence of time-consuming processes are utilized, such as grinding, polishing, molding, and coating, each of which is critical in achieving the desired optical properties and quality for lenses. The revolution of optical systems often comes with the advance of manufacturing processes. Polishing enabled the first generation of telescopic optics centuries ago. Precision CNC machining was a giant leap to modernize aspheric and freeform lenses decades ago. Precision molding of lenses democratized the wider use of optic lenses, empowering the cameras in electronics, such as cell phones, computer, machine vision and artificial intelligence (AI) years ago.

Additive manufacturing, or three-dimensional (3D) printing, will be potentially the next generation of lens making, leading to rapid lens fabrication that facilitates quick and cost-effective lens prototype development, while also expediting innovation and customization across industries, including custom eyewear, vision correction devices, scientific instrumentation, and medical devices. Additive manufacturing is a process of creating physical objects by layering material based on a computer-aided design (CAD) model. Its function has quickly expanded beyond that of an industrial prototype process to include a tool for making production-quality parts, which is difficult to do with conventional techniques such as freeform lens. Among all additive manufacturing processes, material jetting is the early commercialized process for lens making, due to the benefit of jetting different types of materials into a single part. But material jetting is slow and limited to water-like less-viscous materials. In comparison, vat photopolymerization (VPP) is commonly used for optical applications due to high precision, fast printing speed, multiple material selections, and affordable imaging light sources. Recent studies demonstrated printing lens in minutes using vat photopolymerization. Besides, additive manufacturing is a promising method to enhance geometric lenses with extra functions. For instance, Alam et al. 3D-printed personalized smart contact lenses with enhanced features, such as built-in sensors and custom textures, offering advantages over traditional methods. In this regard, additive manufacturing will revolutionize traditional manufacturing processes, provide newfound flexibility, precision and functionality, and accelerate lens fabrication timelines across multiple applications.

Though promising in lens making, additive manufacturing is challenged to fabricate optically smooth surfaces due to fundamentally unavoidable stair-stepping defects: laterally pixelated steps within a layer and vertically layered steps. Various attempts have been made to mitigate these step defects. For lateral staircase within a layer, researchers used the grayscale exposure to blur the pixel aliasing and smoothen the curved contour in a layer. Reducing the size of each pixel is another approach to smoothen the printed layer. However, reduced pixel size decreased building size to several millimeters. The authors used unfocused images to smoothen the pixelation defects, without sacrificing the building size. For layered steps, Chen et al., “High-Speed 3D Printing of Millimeter-Size Customized Aspheric Imaging Lenses with Sub 7 nm Surface Roughness,” Advanced Materials, Vol. 30, No. 7, 1705683 (2018) introduced a CLIP process combining grayscale exposure and meniscus coating that fabricates aspherical lenses with surface roughness down to 7 nm after meniscus coating and enabled rapid fabrication of customized optical components using 3D printing. Zhang, Y., Wu, L., Zou, M., Zhang, L., and Song, Y., “Suppressing the Step Effect of 3D Printing for Constructing Contact Lenses,” Advanced Materials, Vol. 34, No. 17, 2107249 (2022), introduced a single droplet continuous 3D printing to fabricate contact eye lenses Xu, Y., Huang, P., To, S., Zhu, L.-M. & Zhu, Z. Low-Cost Volumetric 3D Printing of High-Precision Miniature Lenses in Seconds. Advanced Optical Materials 10, 2200488 (2022) introduced a cost-effective grayscale exposure based single layer 3D printing technique that rapidly and precisely creates miniature lenses with sub-nanometric roughness, suggesting its potential for large-scale precise lens production. Meniscus coating is a common post-processing to reduce the vertical stairs. But it cannot solve this issue and it is hard to control the tolerance and surface shape to achieve very high performance of optical elements. In addition, the standard deviation in the peripheral region using the drop coating method was much higher than expected, which largely affected lens fabrication quality. Continuous printing eliminated the layered steps on the building direction. However, the printed surface is still not smooth due to the pixelated mask images. Besides continuous printing is limited to thin-walled structures for the sake of resin refilling while most lenses are solid with large cross sections. Despite all these tremendous efforts, it is still lacking an effective and efficient method to eliminate the stair-stepping defects vertically and laterally.

The present disclosure, among other aspects, provides a time-effective and cost-effective process to fabricate qualified optical lenses. Vat photopolymerization with LCD light source to fabricate a layered three-dimensional lens. By slightly defocusing the curing image, the lateral pixilation can be largely reduced. Then, spin coating was used to smoothen the layered steps along the building direction. Previously, spin coating on a curved surface was believed to be an un-predictable and un-repeatable process. However, this work shows the opposite: spin coating on printed surfaces can be precisely controlled, creating a highly robust and predictable coating profile. Various experimentation, numerical analysis and modeling of the coating process and its effect on lenses' smoothness and accuracy revealed that sub-micron precision spin coating on 3D-printed surfaces and the conditions for obtaining such precision. Table 1 shows the summary of existing cases in 3D printing lenses and the comparison with the work in fabrication ability, optical performance, and surface characterization of fabricating the optical lens according to some embodiments described herein.

TABLE 1
Comparison of Existing 3D printing lenses

| | | | | | | Layer | | Surface | | Profile | Profile | |
|---|---|---|---|---|---|---|---|---|---|---|---|---|
| Reference | Process | Lens Size | | Lens Type | MTF | Thickness | | Rouhghness | | Accuracy | Tolerance | Post-Processing |
| [1] | VPP | 3 | mm | Aspherical | 161.3 lp/mm | 5 | μm | 13.7 | nm | — | — | Meniscus |
| | | | | | | | | | | | | coating |
| [2] | VPP | 3 | mm | Aspherical | 306.8 lp/mm | — | | 3.4 | nm | 8 μm | −6.8 to | — |
| | | | | | | | | | | | 7.9 μm | |
| [3] | VPP | 3 | mm | Aspherical | 373.2 lp/mm | 5 | μm | 7 | nm | 3 μm | −2.08 to | Meniscus |
| | | | | | | | | | | | 2.98 μm | coating |
| [4] | VPP | 5 | mm | Aspherical | 203.2 lp/mm | — | | 0.614 | nm | — | 2.92 | Meniscus |
| | | | | | | | | | | | | coating |
| [5] | VPP | 25&50 | | Spherical & | 50.8 lp/mm | 25 | μm | — | | ≤2.47% | — | Grinding & |
| | | mm | | Aspherical | | | | | | | | polishing |
| [6] | VPP | 12.7 | mm | Spherical | 143.7 lp/mm | — | | 6 | nm | 0.048 | — | Glass curing |
| | | | | | | | | | | wave | | |
| [7] | VPP | 11 | mm | Contact | 228.1 lp/mm | — | | 1.3 | nm | — | — | Without washing |
| | | | | lens | | | | | | | | |
| [8] | VPP | 0.54 | mm | Microlens | 1.639 μm | — | | 0.91 | nm | — | — | Without washing |
| | | | | arrays | | | | | | | | & air jetting |
| | | | | | | | | | | | | removing |
| [9] | CAL | 2 | mm | Spherical | — | — | | 6 | nm | 10 μm | — | Sintering |
| [10] | TVP | 9 | mm | Spherical | — | — | | 0.334 | nm | 2.2% to 8.0% | — | Meniscus |
| | | | | | | | | | | | | coating |
| [11] | Inkjet | 25 | mm | Spherical | 143.7 lp/mm | 4.1 | μm | 1 | nm | — | ±500 | Depositing extra |
| | | | | | | | | | | | | droplets |

| | | | | | | | | | | | |
|---|---|---|---|---|---|---|---|---|---|---|---|
| [12] | TPP | 2 | mm | Spherical & | 210 lp/mm | — | 2.9 | nm | 3.9% | — | Dissolving & UV |

| | | | Aspherical | | | | | | | | post-curing with |
|---|---|---|---|---|---|---|---|---|---|---|---|
| | | | | | | | | | | | heating |
| Our | VPP | 3 mm | Spherical & | 347.7 lp/mm | 20 | μm | 0.556 | nm | 1 μm | — | Precision spin- |
| work | | to | Aspherical & | | | | | | | | coating |
| | | 70 mm | Axicon & | | | | | | | | |

PDMS lenses

The references to the works described in Table 1 are as follows:
1. Gonzalez-Hernandez, D., Varapnickas, S., Bertoncini, A., Liberale, C. & Malinauskas, M. Micro-Optics 3D Printed via Multi-Photon Laser Lithography. Advanced Optical Materials 11, 2201701 (2023).
2. Juodkazis, S. 3D printed micro-optics. Nature Photon 10, 499-501 (2016).
3. Optical Fabrication, in Optomechanical Systems Engineering 35-56 (John Wiley & Sons, Ltd, 2015). doi:10.1002/9781118809860.ch3.
4. Gissibl, T., Thiele, S., Herkommer, A. & Giessen, H. Two-photon direct laser writing of ultracompact multi-lens objectives. Nature Photon 10, 554-560 (2016).
5. Thiele, S., Arzenbacher, K., Gissibl, T., Giessen, H. & Herkommer, A. M. 3D-printed eagle eye: Compound microlens system for foveated imaging. Science Advances 3, e1602655 (2017).
6. Gibson, I., Rosen, D., Stucker, B. & Khorasani, M. Additive Manufacturing Technologies. (Springer International Publishing, 2021). doi:10.1007/978-3-030-56127-7.
7. Camposeo, A., Persano, L., Farsari, M. & Pisignano, D. Additive Manufacturing: Applications and Directions in Photonics and Optoelectronics. Advanced Optical Materials 7, 1800419 (2019).
8. Baek, J. et al. Mold-Free Manufacturing of Highly Sensitive and Fast-Response Pressure Sensors Through High-Resolution 3D Printing and Conformal Oxidative Chemical Vapor Deposition Polymers. Advanced Materials 35, 2304070 (2023).
9. Shan, Y., Sahu, P., Sundararajan, R. & Mao, H. Rapid and Low-Cost Fabrication of Microfluidic Devices Using Liquid Crystal Display-Based 3D Printing. in (American Society of Mechanical Engineers Digital Collection, 2023). doi:10.1115/IMECE2022-96036.
10. Hua, J., Shan, Y. & Mao, H. 3D Printing Diffraction Gratings and Fresnel Axicons. in (American Society of Mechanical Engineers Digital Collection, 2023). doi:10.1115/IMECE2022-95889.
11. Mao, H., Jia, W., Leung, Y.-S., Jin, J. & Chen, Y. Multi-material stereolithography using curing-on-demand printheads. Rapid Prototyping Journal ahead-of-print, (2021).
12. Wu, L., Dong, Z., Li, F., Zhou, H. & Song, Y. Emerging Progress of Inkjet Technology in Printing Optical Materials. Advanced Optical Materials 4, 1915-1932 (2016).

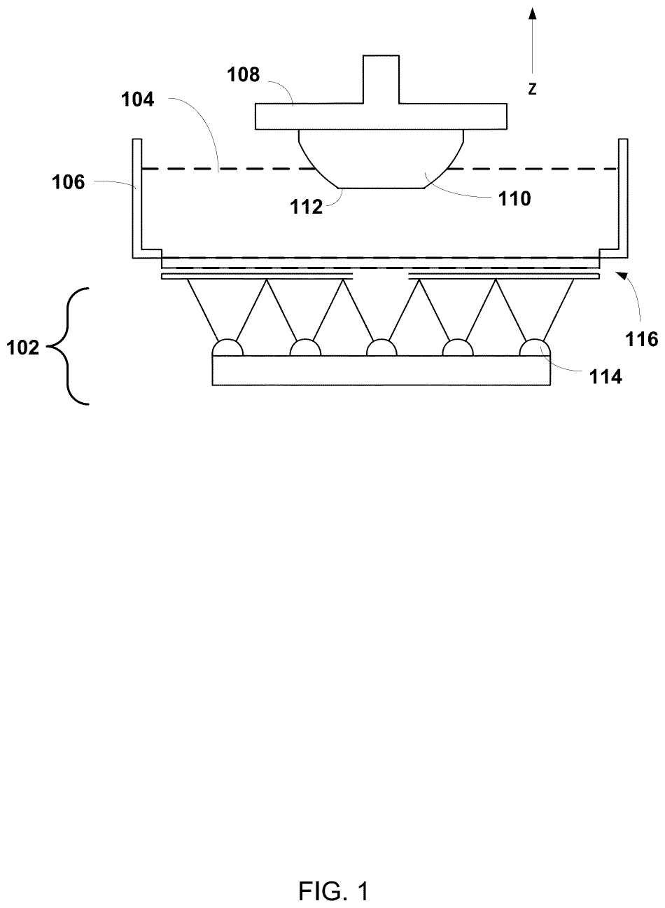

FIG. 1 illustrates an example of a VPP-based 3D printing system. The printer may include a light source 102 configured to project defocus UV light patterns onto a photocurable resin 104 in a resin tank 106. The resin 104 may cure on a build platform 108 which translates along a print direction Z during printing. The light source 102 may cure the resin to form a work piece 104. The workpiece 104 is printed a layer 112 at a time in response to the light source 102 projecting light onto the work piece and the build plate translating along the print direction Z.

The light source may include a light emitter 114 and a screen 116. The light emitter may include, for example, a light emitting diode. The screen may include, for example, a liquid crystal display screen. During operation, the screen may selectively projected sliced 2D images onto the build platform 108, facilitating the curing of the liquid resins in the resin vat. In some examples, the building plate facilitates the Z-direction linear motion of the printed objects with a precision of a 10 μm minimum step.

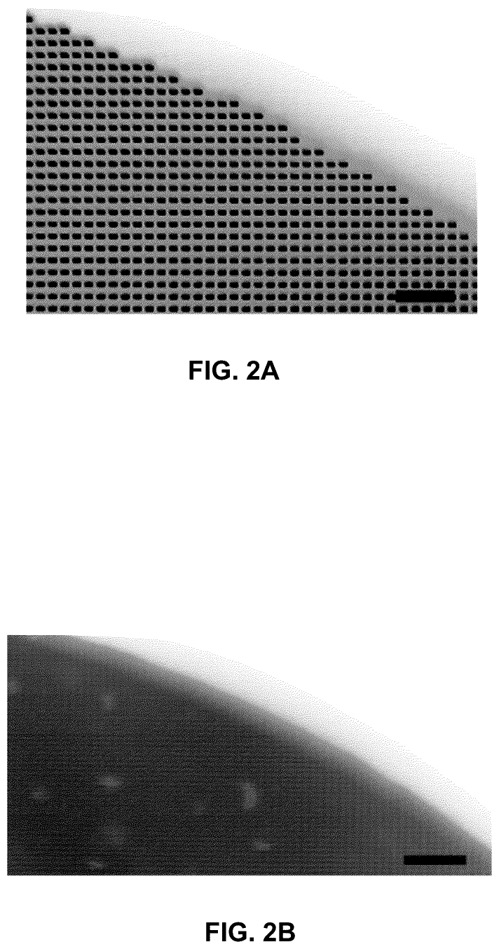

FIG. 2A-B illustrates SEM images of lateral surface pixilation in a print layer with and without defocusing. To provide backlighting for the LCD panel, a powerful UV LED light source is utilized. However, an observed challenge arises when polarized light meets the boundaries of the LCD transistors, leading to most of the light being obstructed. This phenomenon manifests as a grid-type shadow, as depicted in FIG. 2A. Such dark grids contribute to pixel disconnection and uneven light intensity distribution, ultimately producing a stair-stepping pixilation on the lateral surfaces, along the edges.

By manipulating the LCD screen's movement in the printing direction, we can project an unfocused image pattern, enhancing the smoothness of the printed structures for individual layers, as illustrated in FIG. 2B.

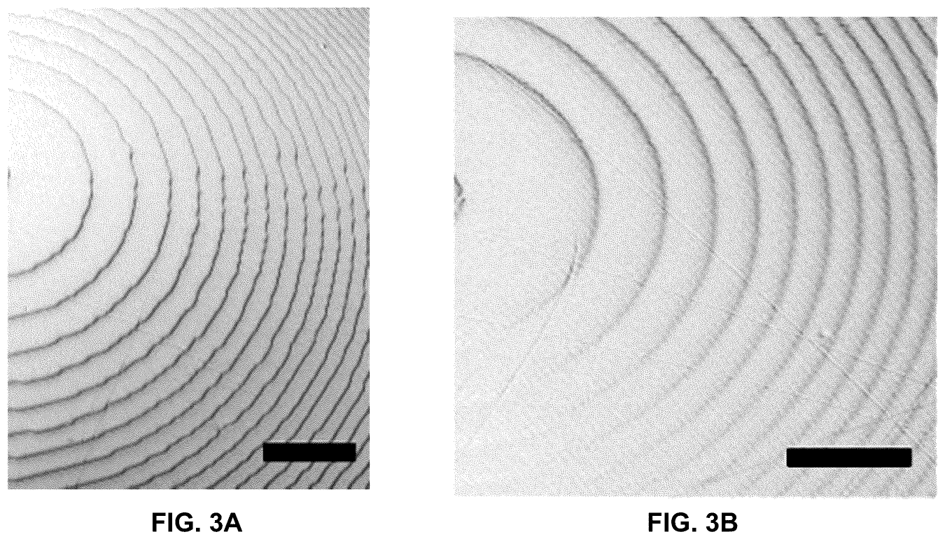

Another problem for print lenses is that vertical stair-stepping can occur between layers. The lens may be post-processed, which includes spin coating the lens to smoothen the vertical stair-stepping. FIG. 3A-B illustrate SEM images of the vertical stair-stepping for a 3D printed lens before and after spin coating.

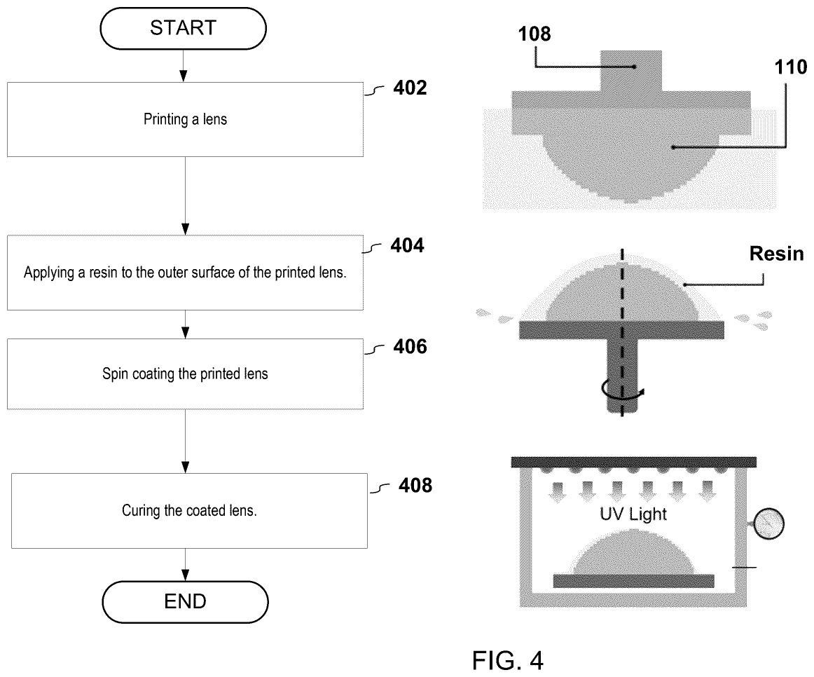

FIG. 4 illustrates a flow diagram for manufacturing the lens. The lens may be printed printing using a 3D printer (402). For example, the 3D printer may include a vat photopolymerization (VPP) printing. During the printing, the image print patterns may be defocused to reduce lateral surface pixelation. For example, the focal plane of a UV light source may be adjusted relative to an LCD mask to blur pixel edges.

A resin may applied to the outer surface of the printed lens (404). The resin is applied such that the amount of resin exceeds the volume of the stair-stepped regions on the printed lens surface. The resin may be clear and applied to cover the lenses outer surface. The resin is applied before spinning such that the amount of resin exceeds the volume between the printed lens surface and the desired profile.

### Define the Volume of the Stair Stepped Region

Then, the resin coat lens may be spin coated (406). In some embodiments, the lens may be spun at a rotational speed between 500 rpm and 2000 rpm for a duration between 10 and 60 seconds. In various experimentation, the lens was spin coated at 1000 rpm for 15 s, however other speeds and times are possible. Ultimately, a speed and time should be selected such that the residual resin distributed uniformly on the outer surface to cover the staircase of the printed sample.

After spin coating, the lens is cured (408). The curing may be performed, in some examples, in an air-tight chamber, which can extract oxygen to avoid the curing inhibition effect and get rid of bubbles inside the coated thin layer of fresh resin. A UV light source may applied to post-cure the coated sample. In various experimentation, the UV light source cured the sample for 40 s.

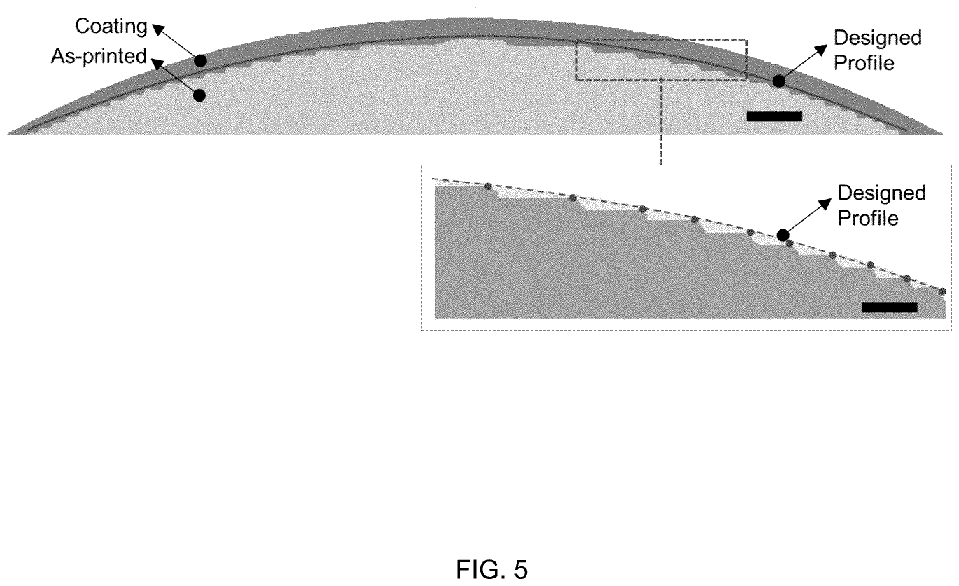

FIG. 5 shows illustrate a measured coating profile of a spin coated lens. measurement of spin coating. The zoomed out scale bar is 1 mm and close-up scale bar is 100 um.

Precision spin coating is a critical step in the lens fabrication. Before spin coating, the resin on the coated lens may exceed the desired profile. The desired profile is the contour of the desired outer surface of the lens as designed. The desired profile may be defined in a design file, such as a STL or other design file which is used for 3D printing.

Compared with drop coating with gravity only, spin coating has at least three benefits. First, spin coating enables the coating of concave lens by using centrifugal force to drain out the resin in the concave lens, whereas the resin will be stuck in drop coating. Second, spin coating is much faster than drop coating. For example, a couple of hours are required for drop coating to drain out the resin while spin coating only needs tens of seconds. Thirdly, spin coating leads to a more uniform coating with sub-microns' variation in the thickness through the major portion of a spherical lens. In comparison, drop coating yields about eight micrometers' deviation in coating thickness across the lens. Additionally, atomic force microscopy (AFM) measurements in various experimentation revealed that the surface roughness of lens sample is 0.556 nm over a 10×10 μm sampled area after spin coating treatment.

Usually, spin coating on a curved surface is viewed as an un-predictable and un-repeatable process. However, modeling and experiments revealed the opposite: spin coating on printed surfaces can be accurately controlled, creating a highly robust and predictable coating profile.

(1) The coating on a 3D-printed surface is equivalent to coating on a smooth spline interpolating all printing layers' corner points.

We found that printed stairs will not affect the profile if the amount of liquid is larger than the volume of the triangled staircases. In spin coating, the liquid is shaped by four forces: surface tension, centrifugal force, gravity, and viscous force. Among them, surface tension quickly forces the liquid to form a smooth surface within a split millisecond, while the gravity and centrifugal force acts much slower in terms of seconds. Such phenomena lead to the solution is insensitive to the staircases, as the surface tension will swiftly smoothen the printed layer steps and stay in nearly hydrostatic equilibrium. For example, in various simulation, the initial profile is set as zig-zag uneven. After only ten microseconds, the zig-zag profile flattens. This result was also validated in our experiments.

(2) Coating thickness is in-sensitive to the initial thicknesses and can be analytically predicted as a function of time and lens profile.

We simulated the coating profile under various initial thickness. We found that regardless of the initial coating conditions, the coating profile will converge to the same profile. The converged profile can be analytically modeled as a function of time (t) and geodesic distance(s) from the point (r,z) to the center along the lens surface:

$$h ( t , s ) = \frac{1}{\sqrt{t + {t}_{0}}} {f ( s )}^{- \frac{1}{3}} \sqrt{{\int }_{0}^{s} r ( s ) {f ( s )}^{- \frac{1}{3}} ds} \qquad Eq . 1$$

$$where$$

$$f ( s ) = \frac{ρ ( {ω}^{2} {r}^{2} cos θ + rg sin θ )}{η} .$$

$${t}_{0} = \frac{0.75 η}{ρ {h}_{0}^{2} ( {ω}^{2} + g / R )}$$

FIG. 6 illustrates analytical modeling of a lens manufactured according go the present disclosure. R is the radius of curvature at the center, h₀ is the initial height in center point's coating thickness, ω is the spin speed, and ρ, η are the density and viscosity of the coating resin.

In various experiments, the radius was 15 mm, spin speed was 1000 rpm, η=0.370, ρ=1090 kg/m³, h₀=1 mm, and t₀=0.022 s. We spin coated for 20 s, which is 1000 times larger than to. We measured the rheological properties of the liquid resin (Newtonian fluid), where the shear stress-shear rate curve is a straight line passing through the origin. The viscosity of our resin was obtained as 0.370 Pa·s by calculating the slope of this line.

(3) The accuracy of coating thickness can be controlled within 1 μm.

Consider initial thickness at center ranges from h₀ to h₁. Then the percentage variation of coating thickness is bounded as

$$\frac{Δ h ( t )}{h ( t )} = \frac{{t}_{0}}{2 t}$$

$$where$$

$${t}_{0} = \frac{0.75 η}{ρ {h}_{0}^{2} ( {ω}^{2} + g / R )} .$$

In various experiments, the spin coating time is larger than 1000 times to:

$${t}_{0} = \frac{0.75 η}{ρ {h}_{0}^{2} ( {ω}^{2} + g / R )}$$

This leads to the temporal accuracy within 0.05% of the coating thickness, which is less than 0.02 μm for a coating thickness of 40 μm. This astonishing result shows that the variations of coating different samples are well controlled with 1 μm. The effect of initial coating thickness was quickly mitigated. The variation of coating thickness under different conditions was reduced to submicron after 20 seconds and was further reduced to 10 nm after 90 seconds. In this case, we considered the coating thickness of the lens center and the resin's viscosity is 0.370 Pa·s, and its density is 1090 kg/m\hat{ }3.

Both our simulation and physical experiments revealed the coating has varying thickness at different locations. In this regard, the coated lens slightly deviates from the designed profile. Geometric compensation for varying coating thickness is feasible but not necessary. To compensate for the deviation, we reversely slim the design so that the coated lens has the exactly designed profile.

The modeling and simulation results verified two critical hypotheses: (1) the layer stair does not affect the coating profile; and (2) the initial amount of coating resin does not affect the coating profile after a critical spin time. These two results theoretically ensure the repeatability and reliability of the coating process. This predictable coating is the foundation for 3D printed lens to have submicron level profile accuracy, which is higher than most conventional lens fabrication process, such as molding or CNC machining.

Accordingly, among other aspects, the present disclosure provides an efficient micro-stereolithography method for rapid 3D printing of imaging lenses. By combining defocusing photopolymerization with a spin coating equilibrium post-curing process, pixelated surface imperfections may be eliminated from the conventional printing technique, all while maintaining fast production speeds. The technique has proven its ability to produce optical components with excellent surface smoothness (<1 nm), impressive precision (<1 μm), and consistent reproducibility, making it a robust solution for creating custom optical parts from optimized designs. These lenses not only have minimal distortion but also display outstanding optical clarity across the visible light spectrum. Moreover, multi-scale lenses with diameters ranging from 3 mm to 70 mm were successfully printed to verify the effectiveness of the proposed method. An array of lenses can be fabricated in a single print, which can reduce the printing time for each lens to 3 minutes. Enhancements can be made to the mask projection system, like further optimizing light intensity and reducing pixel dimensions to achieve high printing resolution. In summary, our findings spotlight the vast promise of 3D printing in the optical realm, paving the way for innovative devices that could revolutionize freeform optics and optical imaging systems. In this paper, we mainly printed symmetrically shaped single optical lenses, and complex optical system designs with assembly printed will be further researched.

The following description provides additional techniques for manufacturing according to some embodiments and experimentation. Photocurable Resin—tor the sample printing, a transparent photocurable resin (high clear) purchased from ANYCUBIC Technology Co., Ltd. China was employed. The density, viscosity, and surface hardness of the resin are 1.09 g/cm³, 370 mPa s, and 78 HS, respectively. The refractive index of printed resin was measured at about n=1.50, which is close to the substrate material of Spherical lenses (Thorlabs, Inc.), N-BK7 glass (n=1.515). Additionally, another clear ANYCUBIC resin was used to print the optical lenses to demonstrate the generality of the proposed fabrication process.

VPP-based 3D Printing System—The customized VPP 3D printing system was developed to manufacture optical lenses. This system combined a commercial resin printer (Phrozen Sonic Mini 8K) purchased from Phrozen Technologies LLC and our defocusing image projection system which was demonstrated in our previous work. This printer utilizes a liquid-crystal display (LCD) screen as the dynamic mask with a maximum printing size of 165×72 mm². This LCD screen contains 7680×4320 pixels with each pixel size of 22×22 μm². The designed digital model was sliced in Chitubox into a number of 2D image patterns with 20 μm thickness along the Z-Axis to build whole samples. 4 A wavelength of 405 nm UV LED light source was employed as the light source. During the printing process, the LCD screen selectively allows the UV light to pass through to achieve different pattern projections. Another printer (Mars 3 Pro) purchased from ELEGOO Inc. was also used to print some optical lenses to demonstrate the generality of the proposed printing method. The printing settings of these two printers were tested and optimized for our lens printing, which was demonstrated in Tables 2 and 3. The digital model was designed in SolidWorks and saved as STL files with maximum fine structures, which aims to minimize the size of sliced triangles and get better surface quality and structural precision in our lens fabrication.

TABLE 2
Printing settings of customized printing
setup (Phrozen Mini Sonic 8K)

| Layer | Exposure | Rest | Lift | Lift/Retract | |
|---|---|---|---|---|---|
| Height | Time | Time | Distance | Speed | Grayscale |
| 20 μm | 4.5 s | 2 s | 5 mm | 30 mm/min | Yes |

TABLE 3
Printing settings of customized printing setup (Mars 3 Pro)

| Layer | Exposure | Rest | Lift | Lift/Retract | |
|---|---|---|---|---|---|
| Height | Time | Time | Distance | Speed | Grayscale |
| 20 μm | 4 s | 2 s | 4 mm | 30 mm/min | Yes |

Precision Spin Coating Method—After the printing process, the printed sample printed on the glass slide was moved to a spin coater. After centering the printed sample, the cleaned bottom surface of the slide was attached to the chuck using a vacuum. The new liquid resin was manually dispensed the liquid onto the center of the printed sample to make sure enough resin was distributed on the whole top surface. Then, the sample was spun at low speeds of 1000 rpm/min to spread the liquid resin for 20 s. The new uncured resin uniformly covered the curved top surface of the printed lens with layers along the printing direction and formed the demanded spherical surface.

Post-Processing Method—After spin coating, a thin layer of resin was uniformly distributed on the surface of the printed lens. To avoid the oxygen inhibition effect on the liquid resin curing process, a customized post-curing device was used as shown in FIG. 2b. In this setup, a 405 nm 3 W UV lamp was embedded in a vacuum chamber. The spin-coated sample with glass substrate was put into the chamber. When the air pressure reached 29 inHg, the UV lamp was turned on for 40 s for post-curing. By utilizing different resins, the post-curing time will be different. Once the lens was fully cured, it was transferred from the silicon printing substrate onto a quartz substrate (Oxford Instruments), which is highly transparent to UV light and widely used in optical components. To bond the lens and quartz glass, the same resin was dropped on the quartz glass's surface and the printed lens was immerged into the liquid resin. After an additional UV curing step, these two parts were fully adhered, which can also avoid the air gap between these parts.

Bubble Avoid—In VPP 3D printing, the bubble is a big issue during the curing process, which will be badly affected printing quality, surface performance, and mechanical properties, especially for bottom-up setup. The bubbles come from two situations (1) small bubbles in liquid resin self (2) building platform drop into liquid material and separation between each printing layer, which will generate an empty region waiting for liquid refilled before the next layer printing. To avoid bubble issues, the fresh resin was first vacuumed for 30 mins to make sure all small bubbles came out from the liquid and then slowly poured into the printing tank. For the printing process, after leveling calibration, the building platform moved down and immersed into the resin at the speed of 200 um/s to the first layer height (20 um) instead of directly moving to the Zero position and moving back to the first layer. Next, the building platform was moved up to 40 mm to manually check and remove the potential bubbles using a syringe. Then it slowly moved back to the first layer position and started the printing process. For lifting and retraction, the speed is set at 30 mm/min to avoid bubble generation when the sample is peeled off from the FEP film, which can suddenly create a vacuum area and bubbles will come out randomly.

Optical Characterization of the 3D Printed Lenses—The optical performance of the 3D-printed aspheric lens was characterized by the USAF 1951 resolution test target (R1DS1N, Thorlabs, Inc.). Multiple bandpass filters with center wavelengths of 532 nm (FLH532-10, Thorlabs), 450 nm (FBH450-10, Thorlabs), and 650 nm (FBH650-10, Thorlabs) were inserted into the microscope for green, blue, and red illumination. The resolution test target was placed at the front focal plane of the 3D-printed aspheric lens and the image was collected and analyzed via the inverted microscope body. The camera captured the projection images passed from the resolution target for quantification.

Surface Characterization of the 3D Printed Lenses—Images from the Scanning Electron Microscopy (SEM) were acquired using a Teneo Volume Scope SEM (Field Electron and lon Inc., USA) in the backscattered electron mode to capture the surface details. We used an accelerating voltage of 5 kV and a beam current of 10 nA for the analysis. All the samples were first mounted on aluminum stubs using double-sided tape, then coated with a gold layer through a Baltec SCD 005 vacuum sputter coater for 60 seconds at a 0.1 mbar vacuum to prepare them for observation. To get the surface profile, an imaging system was employed to capture the 2D profiles of the printed lenses. The designed and actual cross-section profiles were matched to record the printing errors. The surface roughness of printed samples was measured using an AFM.

Simulation of Spin Coating—COMSOL Multiphysics was used to model and simulate the spin coating process. The simulation domain was set as 2D axisymmetric. The spin coating on substrates with layer stairs was modeled as a two-phase laminar flow with phase method. The spin coating on smooth aspherical surface was modeled using a two-phase laminar flow with moving mesh method. The viscosity and density of the coating resin was mentioned in previous section. Liquid-gas interface was used for the two-phase interaction.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method for fabricating an optical lens, comprising:
providing a digital model of a lens;
printing the lens using a vat photopolymerization (VPP) process such that the lens comprises a plurality of discrete layers along a print direction;
projecting, during the printing, defocused image patterns to reduce lateral surface pixelation in each of the layers;
applying a photocurable resin to an outer surface of the printed lens;
spin coating the lens which distributes the resin uniformly across the outer surface of the lens and smooths layered steps of the print layers along the print direction; and
curing the resin that is coated to the lens.

2. The method of claim 1 where projecting, during the printing, the defocused image patterns to reduce lateral surface pixelation in each of the layers comprises directing light from a UV light source through a liquid crystal display (LCD) mask.

3. The method of claim 2, wherein defocusing the image pattern comprises adjusting the focal plane of the UV light source relative to the LCD mask to blur pixel edges.

4. The method of claim 2, wherein the LCD mask includes a resolution of at least 7680 pixels in a first dimension and 4320 pixels in a second dimension.

5. The method of claim 1, wherein the printed lens comprises a spherical, aspherical, or axicon geometry.

6. The method of claim 1, wherein the cured lens has a surface roughness of less than 1 nanometer.

7. The method of claim 1, wherein the cured lens has a profile deviation of less than 1 micrometer from a target digital model, wherein the profile deviation is a distance between the surface of the cured lens and a lens surface as defined in the digital model.

8. The method of claim 1, wherein spin coating comprises:
spinning the lens at a rotational speed between 500 rpm and 2000 rpm for a duration between 10 and 60 seconds.

9. The method of claim 1, wherein the resin is applied before spinning such that the amount of resin exceeds the volume of stair-stepped regions on the printed lens surface.

10. The method of claim 1, further comprising performing the curing step in a vacuum chamber to inhibit oxygen-induced curing defects.

11. The method of claim 1, wherein the printer prints the lens with a resin, wherein the resin placed in a vacuum prior to printing.
